(19) United States
(12) Patent Application Publication
(10) Pub. No.: US 2026/0204809 A1
(43) Pub. Date: Jul. 16, 2026

(54) TERMINAL-EQUIPPED ELECTRIC WIRE AND METHOD OF MANUFACTURING TERMINAL-EQUIPPED ELECTRIC WIRE

(71) Applicant: Yazaki Corporation, Tokyo (JP)

(72) Inventor: Masashi IWATA, Shizuoka (JP)

(73) Assignee: Yazaki Corporation, Tokyo (JP)

(21) Appl. No.: 19/421,060

(22) Filed: Dec. 16, 2025

(30) Foreign Application Priority Data
Jan. 14, 2025 (JP) 2025-004888

(51) Int. Cl. H01R 4/18; H01R 43/048

(52) U.S. Cl. CPC H01R 4/184; H01R 43/048

(57) ABSTRACT

A terminal-equipped electric wire includes an electric wire and a crimp terminal. The electric wire has a configuration in which a conductor unit having conductivity is covered with an insulating covering member having insulating properties. The crimp terminal includes: a conductor crimp member crimped to the conductor member exposed from an end of the insulating covering member; an electrical connection member electrically connected to a connection partner; and a coupling member coupling the conductor crimp member and an electrical connection member to each other. The conductor member includes a conductor exposed portion that protrudes from the conductor crimp member toward the coupling member and is exposed to the outside, in the crimped state. The distal end surface of the conductor exposed portion is colored differently from the color of the coupling member.

### CROSS-REFERENCE TO RELATED APPLICATION(S

The present application claims priority to and incorporates by reference the entire contents of Japanese Patent Application No. 2025-004888 filed in Japan on January 14, 2025.

### BACKGROUND OF THE INVENTION

### 1. Field of the Invention

The present invention relates to a terminal-equipped electric wire and a method of manufacturing the terminal-equipped electric wire.

### 2. Description of the Related Art

In conventional an electric wire connection structure of a terminal, for example, an aluminum wire in which an aluminum conductor member (core wire) is covered with an insulating covering member and a terminal are welded to each other by ultrasonic welding (refer to JP 2015 – 185283 A). JP 2015 - 185 283 A describes, as a procedure after ultrasonic welding of a core wire and a terminal, performing visual confirmation as to whether a front end of a core wire welded portion is located between a second positioning member and a first positioning member.

As in the above-described conventional technique, for example, in order to improve the inspection accuracy by visual confirmation, a positioning rib is formed or a notch or the like is provided in the terminal as the inspection position. However, this method has a possibility to complicate the shape of the terminal, and thus there is room for improvement.

### SUMMARY OF THE INVENTION

An object of the present invention is to provide a terminal-equipped electric wire and a method of manufacturing the terminal-equipped electric wire capable of easily performing quality confirmation.

In order to achieve the above mentioned object, a terminal-equipped electric wire according to one aspect of the present invention includes an electric wire in which a conductor member having conductivity is covered with an insulating covering member having insulating properties; and a crimp terminal including a conductor crimp member crimped to the conductor member exposed from an end of the insulating covering member, an electrical connection member electrically connected to a connection partner, and a coupling member coupling the conductor crimp member and the electrical connection member to each other, wherein the conductor member includes a conductor exposed portion that protrudes from the conductor crimp member toward the coupling member side and is exposed to the outside in a crimped state in which the conductor crimp member is crimped to the conductor member, and a distal end surface of the conductor exposed portion undergoes coloring with a color different from a color of the coupling member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view illustrating a schematic configuration of a terminal-equipped electric wire according to an embodiment;

FIG. 2 is a partially enlarged view illustrating a main part of the terminal-equipped electric wire of FIG. 1;

FIG. 3 is a flowchart illustrating a flow of a method of manufacturing a terminal-equipped electric wire according to the embodiment; and

FIG. 4 is a schematic diagram for illustrating a coloring step in step S3 of FIG. 3.

### DETAILED DESCRIPTION OF THE PREFERRED EMBODIMENTS

Hereinafter, an embodiment according to the present invention will be described in detail with reference to the drawings. Note that the present invention is not limited by the embodiment described below. That is, constituent elements in the following embodiment include those that can be easily assumed by those skilled in the art or those that are substantially the same, and various omissions, substitutions, and modifications can be made without departing from the scope and spirit of the invention.

### EMBODIMENT

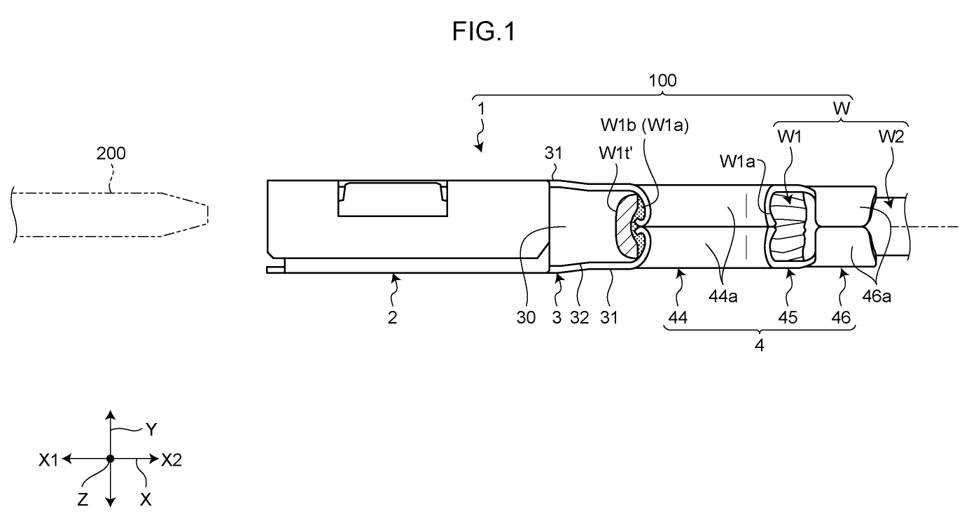

A terminal-equipped electric wire 100 illustrated in FIG. 1 is applied to a wire harness or the like used for a vehicle (not illustrated) such as an automobile. The wire harness is formed as a component assembly obtained by bundling a plurality of electric wires W used for power supply and signal communication to achieve connection between devices mounted on a vehicle, with the plurality of electric wires W connected to each of the devices via connectors or the like. The terminal-equipped electric wire 100 of the present embodiment includes an electric wire W and a crimp terminal 1 crimped to the end of the electric wire W.

In the following description, an X direction in the drawing is referred to as an "extending direction X", a Y direction is referred to as a "width direction Y", and a Z direction is referred to as a "height direction Z". The extending direction X, the width direction Y, and the height direction Z are orthogonal to each other. In the extending direction X, one direction is defined as a "first direction X1" and the other direction is defined as a "second direction X2". The width direction Y and the height direction Z are included in a direction orthogonal to the extending direction X. In addition, unless otherwise specified, each direction used in the following description represents a direction in a crimped state, that is, a state in which the crimp terminal 1 is crimped to the electric wire W.

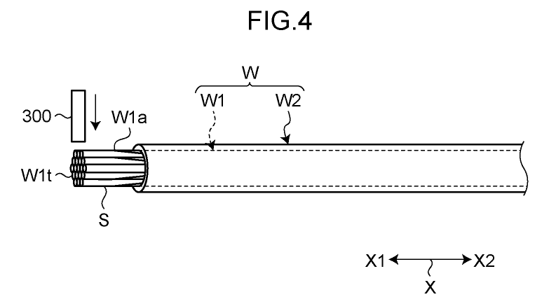

First, the electric wire W will be described with reference to FIG. 1 (including FIG. 4). The electric wire W includes: a conductor member W1 having conductivity; and an insulating covering member W2 having insulation properties and covering the outside of the conductor member W1. The electric wire W is obtained by covering the conductor member W1 with the insulating covering member W2. In the electric wire W of the present embodiment, the insulating covering member W2 is peeled off at at least one end (in FIG. 4, the first direction X1 side end), the conductor member W1 is exposed from the end of the insulating covering member W2 to form an exposed conductor end portion W1a.

The conductor member W1 is a core wire obtained by bundling a plurality of metal wires S having conductivity. The conductor member W1 has a substantially circular cross-sectional shape when viewed in the extending direction X. The conductor member W1 may be a stranded core wire obtained by twisting the plurality of metal wires S.

The insulating covering member W2 is an electric wire covering that covers the outer circumferential side of the conductor member W1. The cross-sectional shape of the insulating covering member W2 viewed in the extending direction X is a substantially annular shape. The insulating covering member W2 is obtained by performing extrusion molding using, for example, resin materials having insulating properties (polypropylene (PP), polyvinyl chloride (PVC), cross-linked polyethylene (PE), etc., appropriately selected in consideration of abrasion resistance, chemical resistance, heat resistance, etc.)

Regarding the electric wire W, the crimp terminal 1 is crimped to the vicinity of the end of the insulating covering member W2 and the exposed conductor end portion W1a exposed from the end of the insulating covering member W2.

As illustrated in FIG. 4, the exposed conductor end portion W1a has a distal end surface W1t formed by cutting the conductor member W1. The distal end surface W1t is a cut surface formed by cutting the conductor member W1 before the crimp terminal 1 is crimped to the electric wire W. The distal end surface W1t is an aggregate of cut surfaces of the plurality of metal wires S, and has a substantially circular shape as viewed in the extending direction X, similarly to the conductor member W1, in a state before the crimp terminal 1 is crimped to the electric wire W. The distal end surface W1t of the present embodiment is colored differently from the color of the surface of the crimp terminal 1 using a coloring material 300 to be described below, for example.

Next, the crimp terminal 1 will be described with reference to FIG. 1. The crimp terminal 1 is a terminal fitting to which the electric wire W is electrically connected and to which a connection partner 200 having conductivity is connected. The connection partner 200 is, for example, a terminal formed of a conductive metal material and to which the crimp terminal 1 can be connected.

The crimp terminal 1 of the present embodiment includes an electrical connection member 2, a coupling member 3, and an electric wire crimp member 4. The electrical connection member 2, the coupling member 3, and the electric wire crimp member 4 are integrally formed of a conductive metal member as a whole. The crimp terminal 1 is obtained from, for example, one sheet metal, which is a metal member, molded by various types of processing such as pressing and bending according to a shape corresponding to each part including the electrical connection member 2, the coupling member 3, and the electric wire crimp member 4, so as to three-dimensionally integrally form each part. In the crimp terminal 1, the electrical connection member 2, the coupling member 3, and the electric wire crimp member 4 are arranged and mutually coupled in this order from the first direction X1 side toward the second direction X2 side in the extending direction X.

The electrical connection member 2 is a portion electrically connected to the connection partner 200. The electrical connection member 2 may have a male terminal shape or a female terminal shape. The electrical connection member 2 of the present embodiment is illustrated as having a female terminal shape, and is electrically connected to the connection partner 200 having a male terminal shape. The electrical connection member 2 is not limited to the mating terminal, and may be configured to be electrically connected to various conductive members such as a ground member. In this case, the electrical connection member 2 may have a shape referred to as a round terminal (LA terminal) shape to be fastened to a member such as a ground member, for example.

The coupling member 3 is a portion interposed between the electrical connection member 2 and the electric wire crimp member 4 to couple the electrical connection member 2 and the electric wire crimp member 4 to each other. The coupling member 3 is formed to have a substantially rain pipe-like cross-sectional shape when viewed in the extending direction X. In the crimped state in which the crimp terminal 1 is crimped to the electric wire W, the coupling member 3 is open to one side in the height direction Z, and has a part of the exposed conductor end portion W1a exposed to the outside.

The coupling member 3 includes a bottom plate 30, a pair of side plates 31, and an opening 32. The bottom plate 30 and the side plates 31 are coupled to the electrical connection member 2 on each first direction X1 side, and are coupled to the electric wire crimp member 4 on the second direction X2 side. The bottom plate 30 has a substantially constant width in the width direction Y and extends in the extending direction X. The side plates 31 are erected in the height direction Z from both end portions positioned in the width direction Y of the bottom plate 30. The opening 32 is located between the electrical connection member 2 and the electric wire crimp member 4 in a crimped state in which the crimp terminal 1 is crimped to the electric wire W, and is formed by a pair of side plates 31 facing each other in the width direction Y. The opening 32 opens toward one side in the height direction Z in a crimped state in which the crimp terminal 1 is crimped to the electric wire W.

The electric wire crimp member 4 is a portion that is caulked to the end of the electric wire W provided with the exposed conductor end portion W1a to electrically connect the end of the electric wire W and the crimp terminal 1 to each other. The electric wire crimp member 4 is crimped to the end of the electric wire W. The electric wire crimp member 4 includes a conductor crimp member 44, an intermediate member 45, and a covering crimp member 46. In the electric wire crimp member 4, the conductor crimp member 44, the intermediate member 45, and the covering crimp member 46 are arranged and mutually coupled in this order from the coupling member 3 side toward the second direction X2 side in the extending direction X.

The conductor crimp member 44 includes a pair of barrel pieces 44a. The barrel piece 44a is a projecting piece that is formed in a band shape and is formed to protrude in the height direction Z from both end portions located in the width direction Y of the bottom plate continuously formed in the extending direction X on the bottom plate 30. The exposed conductor end portion W1a is caulked by the pair of barrel pieces 44a, so as to crimp the electric wire crimp member 4 to the electric wire W.

The intermediate member 45 is a portion that is interposed between the conductor crimp member 44 and the covering crimp member 46 to couple the conductor crimp member 44 and the covering crimp member 46 to each other. The intermediate member 45 has a substantially rain pipe cross-sectional shape as viewed in the extending direction X. In the crimped state in which the crimp terminal 1 is crimped to the electric wire W, the intermediate member 45 opens to one side in the height direction Z and exposes the other part of the exposed conductor end portion W1a to the outside.

The covering crimp member 46 includes a pair of barrel pieces 46a. The barrel piece 46a is a projecting piece formed in a band shape and formed so as to protrude in the height direction Z from both end portions located in the width direction Y of the base portion (not illustrated). Part of the insulating covering member W2 is caulked by the pair of barrel pieces 46a, so as to crimp the electric wire crimp member 4 to the electric wire W.

The terminal-equipped electric wire 100 of the present embodiment includes a conductor exposed portion W1b that protrudes from the conductor crimp member 44 toward the coupling member 3 so as to be exposed to the outside in the crimped state in which the crimp terminal 1 is crimped to the electric wire W. The conductor exposed portion W1b is located between the pair of side plates 31 and on the bottom plate 30 when viewed from one side in the height direction Z of the terminal-equipped electric wire 100. The conductor exposed portion W1b is formed by crimping the conductor crimp member 44 to the conductor member W1. Here, the crimped state is a state in which the conductor crimp member 44 is crimped to the conductor member W1 and the covering crimp member 46 is crimped to the insulating covering member W2. Crimping the conductor crimp member 44 to the conductor member W1 means crimping the conductor crimp member 44 to the exposed conductor end portion W1a.

The conductor exposed portion W1b has a distal end surface W1t' colored differently from the color of the coupling member 3 in a crimped state in which the crimp terminal 1 is crimped to the electric wire W. The distal end surface W1t', being the distal end surface W1t, has its shape relatively deformed by crimping of the crimp terminal 1 to the electric wire W as compared with the shape of the distal end surface W1t.

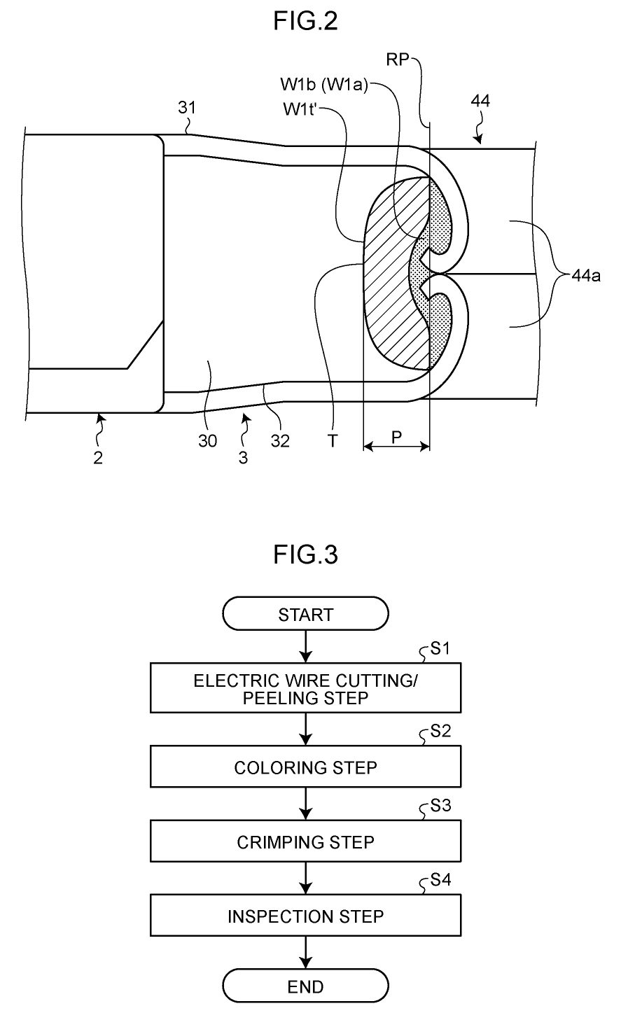

As illustrated in FIG. 2, a distal end position T in the extending direction X of the distal end surface W1t' is set to be within a permissible range P provided on the first direction X1 side from a reference position RP provided on the end on the first direction X1 side of the conductor crimp member 44. The permissible range P is decided by an upper limit value of a conventional core wire protrusion dimension standard.

In the terminal-equipped electric wire 100 configured as described above, the conductor member W1 of the electric wire W to which the crimp terminal 1 is crimped may be formed of a material such as aluminum (Al) or an aluminum alloy, for example. In this case, the conductor member W1 is a core wire obtained by bundling a plurality of metal wires S formed of aluminum or an aluminum alloy. On the other hand, the crimp terminal 1 is formed by plating a surface of a base material formed of a dissimilar metal different from the conductor member W1, for example, copper (Cu) or a copper alloy with tin (Sn) or the like. The aluminum alloy is an alloy containing aluminum as a main component. The copper alloy is an alloy containing copper as a main component, and includes, for example, a material such as brass, etc.

Next, a method of manufacturing the terminal-equipped electric wire 100 will be described. The following description will be given with a flowchart of FIG. 3 with reference to other drawings as appropriate. The method of manufacturing the terminal-equipped electric wire 100 described below may be manually performed by an operator using various devices, apparatuses, jigs, and the like, or may be automatically performed by various manufacturing devices, for example.

The method for manufacturing the terminal-equipped electric wire 100 includes a cutting/peeling step (step S1) of the electric wire W, a coloring step (step S2), a crimping step (step S3), and an inspection step (step S4). These steps can be performed by an in-line method.

First, as the cutting/peeling step (step S1) of the electric wire W, the operator cuts the electric wire W and also performs, in parallel, peeling of a part of the insulating covering member W2 at the end of the electric wire W to expose the end of the conductor member W1 from the insulating covering member W2.

After the cutting/peeling step of the electric wire W, as the coloring step (step S2), the operator colors the electric wire W on the distal end surface W1t of the conductor member W1 exposed from the end of the insulating covering member W2. For example, the operator uses a coloring material 300 to color the distal end surface W1t of the exposed conductor end portion W1a provided in the electric wire W before crimping illustrated in FIG. 4. The coloring material 300 to be used is a product in compliance with the end-of-life vehicles (ELV) directive, for example. In the coloring step, for example, the coloring material 300 is moved and stamped in a direction orthogonal to the extending direction X with respect to the distal end surface W1t by an in-line method.

After the coloring step, the operator performs the crimping step (step S3) to crimp the crimp terminal 1 to the electric wire W. For example, the operator disposes the exposed conductor end portion W1a of the electric wire W on the conductor crimp member 44 of the crimp terminal 1 and caulks the barrel pieces 44a and 46a to crimp the crimp terminal 1 to the electric wire W.

After the crimping step, the operator performs the inspection step (step S4) to inspect whether the distal end position T of the distal end surface W1t' of the conductor exposed portion W1b is within the permissible range P provided from the reference position RP toward the electrical connection member 2 based on the relative position between the colored distal end surface W1t' and the coupling member 3. For example, when the distal end position T of the distal end surface W1t' is not within the permissible range P, the operator determines that the product is not a good product, and when the distal end position T is within the permissible range P, the operator determines that the product is a good product.

In the conventional terminal-equipped electric wire, since the material of the conductor member W1 is aluminum or an aluminum alloy, and the surface of the crimp terminal 1 is plated with tin or the like, the color of the conductor exposed portion W1b and the color of (the bottom plate 30 of) the coupling member 3 (the color of which the surface is plated) are the same color, and it is not easy to visually determine whether the distal end position T of the distal end surface W1t' is within the permissible range P. In addition, even in the case of automatic determination by image processing using a camera, the determination is not easy.

In view of this, the terminal-equipped electric wire 100 of the present embodiment has a configuration in which the distal end surface W1t' is colored in a color different from the color of the coupling member 3, making it easy to determine whether the distal end position T of the distal end surface W1t' is within the permissible range P. That is, the terminal-equipped electric wire 100 can easily determine whether the distal end position T of the distal end surface W1t' is within the permissible range P, for example, either in automatic determination by camera imaging or in visual determination.

As described above, in the terminal-equipped electric wire 100 according to the present embodiment, the conductor member W1 of the electric wire W has the conductor exposed portion W1b that protrudes from the conductor crimp member 44 toward the coupling member 3 in the crimped state and is exposed to the outside. The distal end surface W1t' of the conductor exposed portion W1b is colored differently from the color of the coupling member 3. In addition, the method of manufacturing the terminal-equipped electric wire 100 configured as described above includes: the coloring step (step S2) of applying coloring to the electric wire W, specifically onto the distal end surface W1t of the conductor member W1 exposed from the end of the insulating covering member W2; the crimping step (step S3) of crimping the crimp terminal 1 to the electric wire W; and the inspection step (step S4) of inspecting whether the distal end position T of the distal end surface W1t' is within the permissible range P provided from the reference position RP toward the electrical connection member 2 based on the relative position between the colored distal end surface W1t' and the coupling member 3.

With the above configuration, even when the conductor member W1 of the electric wire W is formed of aluminum, an aluminum alloy, etc. and has the same color as the color of the surface of the crimp terminal 1, it is possible to easily determine whether the distal end surface W1t' of the conductor exposed portion W1b is within the permissible range P. Therefore, the terminal-equipped electric wire 100 and the method of manufacturing the terminal-equipped electric wire 100 can easily confirm the quality of the terminal-equipped electric wire 100. In addition, as compared with the conventional terminal-equipped electric wire, for example, the terminal-equipped electric wire 100 and the method of manufacturing the terminal-equipped electric wire 100 have no need to provide a positioning rib, a notch, or the like provided in the crimp terminal for determining whether the distal end surface W1t' of the conductor exposed portion W1b is within the permissible range P, making it possible to suppress complication of the shape of the crimp terminal.

In addition, the terminal-equipped electric wire 100 and the method of manufacturing the terminal-equipped electric wire 100 determine whether the distal end surface W1t' of the conductor exposed portion W1b is within the permissible range P by relative comparison of different colors instead of the same color, which is suitable for automatic determination by image processing using a conventional camera.

In addition, in the terminal-equipped electric wire 100 and the method of manufacturing the terminal-equipped electric wire 100, the distal end surface W1t is a cut surface formed by cutting the conductor member W1 before the conductor crimp member 44 is crimped to the conductor member W1. That is, since the distal end surface W1t is a cut surface formed by cutting the conductor member W1, a work load can be reduced without increasing a new step (for example, step of processing on the exposed conductor end portion W1a) before coloring the distal end surface W1t.

In the above embodiment, the method of stamping the coloring material 300 has been described as the coloring method applied on the distal end surface W1t in the in-line method, but the present invention is not limited thereto, and coloring may be performed by applying the coloring material to the distal end surface W1t by a dispenser.

In the above embodiment, the coloring step is performed after the cutting/peeling step of the electric wire W. However, the procedure order is not limited thereto, and for example, peeling may be performed after coloring the cut surface of the electric wire W after cutting.

According to the terminal-equipped electric wire and the method of manufacturing the terminal-equipped electric wire according to the present embodiment, it is possible to have an effect of easily confirming the quality of the terminal-equipped electric wire.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal-equipped electric wire comprising:
an electric wire in which a conductor member having conductivity is covered with an insulating covering member having insulating properties; and
a crimp terminal including a conductor crimp member crimped to the conductor member exposed from an end of the insulating covering member, an electrical connection member electrically connected to a connection partner, and a coupling member coupling the conductor crimp member and the electrical connection member to each other, wherein
the conductor member includes
a conductor exposed portion that protrudes from the conductor crimp member toward the coupling member side and is exposed to the outside in a crimped state in which the conductor crimp member is crimped to the conductor member, and
a distal end surface of the conductor exposed portion undergoes coloring with a color different from a color of the coupling member.

2. The terminal-equipped electric wire according to claim 1, wherein
the distal end surface is
a cut surface formed by cutting the conductor member before the conductor crimp member is crimped to the conductor member.

3. A method of manufacturing a terminal-equipped electric wire, the method comprising:
a coloring step of applying coloring to an electric wire in which a conductor member having conductivity is covered with an insulating covering member having insulating properties, specifically, applying coloring on a distal end surface of the conductor member exposed from an end of the insulating covering member;
a crimping step of crimping a crimp terminal to the electric wire after the coloring step, the crimp terminal including a conductor crimp member crimped to the conductor member exposed from the end of the insulating covering member, an electrical connection member electrically connected to a connection partner, and a coupling member coupling the conductor crimp member and the electrical connection member to each other; and
an inspection step of inspecting, after the crimping step, based on a relative position between the colored distal end surface and the coupling member, whether a distal end position of the distal end surface in a conductor exposed portion that protrudes from the conductor crimp unit toward the coupling member side and is exposed to the outside is within a permissible range, the permissible range being provided from a reference position provided in an end of the conductor crimp member on the coupling member side toward the electrical connection member.
